(19) United States
(12) Patent Application Publication
(10) Pub. No.: US 2008/0155814 A1
(43) Pub. Date: Jul. 3, 2008

(54) Attachments for candleholders for safety usage

(76) Inventor: Meir Lerner, Brooklyn, NY (US)

Correspondence Address: Meir Lerner, 525 Kent Ave. #4-c, Brooklyn, NY, 11211, US

(21) Appl. No.: 11/964,704

(22) Filed: Dec. 26, 2007

Related U.S. Application Data
(60) Provisional application No. 60/882,001, filed on Dec. 27, 2006.

(30) Foreign Application Priority Data
Jan. 21, 2007 (US) PCT/US07/60811

(51) Int. Cl. B23P 19/04; F23D 3/16

(52) U.S. Cl. 29/700; 431/297

(57) ABSTRACT

Methods of attachment of a candleholder, with a candle, to a candelabra (or similar device) comprising the steps of providing the candleholder; providing the candelabra; providing attachment means in places of contact of the candleholder and the candelabra; coupling the attachment means to the candleholder; and coupling the attachment means to the candelabra, thereby securing the candleholder to the candelabra. The attachment means in different embodiments are performed as a number (one or more) of predeterminedly shaped double-stick adhesive, or Velcro.™, or magnetic elements, or any combination thereof, placed in locations of contact between the candleholder and the candelabra. In an embodiment, the candelabra is shaped as a cylinder-like body having a first diameter, and the candleholder includes a round bottom having a second diameter greater than the first diameter, wherein the edges of the bottom furnished with aforesaid elements are bendable over the edges of the candelabra.

### CROSS REFERENCE TO RELATED APPLICATIONS

This PCT patent application claims the benefit a U.S. provisional patent application Ser. No. 60/882001 filed on Jan. 27, 2006 the disclosure of which is incorporated herein in its entirety by reference. This PCT patent application also contains a new part not disclosed in the above provisional application.

### TECHNICAL FIELD

The present invention relates to household items, particularly to means providing safety of candleholders securable to candelabras or other similar devices.

### BACKGROUND OF THE INVENTION

It is widely known that candles are often inserted into candleholders typically having a substantially cylindrical shape to enclose candles usually having the same shape. Traditional candleholders are often further placed in candelabras or another similar device (such as menorah, etc.). However, the traditional candleholder can easily fall over from the candelabra, and is unsafe, since may cause a fire.

### BRIEF DESCRIPTION OF THE DRAWINGS TO THE INVENTION

The mentioned and/or other aspects and advantages of the present general inventive concept will become apparent and more readily appreciated from the following description of exemplary embodiments, taken in conjunction with the accompanying drawings of which:

FIG. 1 is a perspective view of an attachment and a candleholder according to a first embodiment of the present invention.

FIG. 2 is a perspective view of an attachment and a candleholder according to a second embodiment of the present invention.

FIG. 3 is a sectional view of an attachment with a candleholder and a candle according to a third embodiment of the present invention.

Similar reference numerals on the drawings generally refer to the same or similar elements on different figures. A newly introduced numeral in the description is enclosed into parentheses.

### DESCRIPTION OF THE INVENTION

While the invention may be susceptible to embodiment in different forms, there are shown in the drawings, and will be described in detail herein, three specific embodiments of the present invention, with the understanding that the present disclosure is to be considered an exemplification of the principles of the invention, and is not intended to limit the invention to that as illustrated and described herein.

The purpose of the present invention is to provide attachments to candleholders, capable to easily fix the candleholder to the candelabra or a similar device, and thereby prevent the candleholder from falling over therefrom.

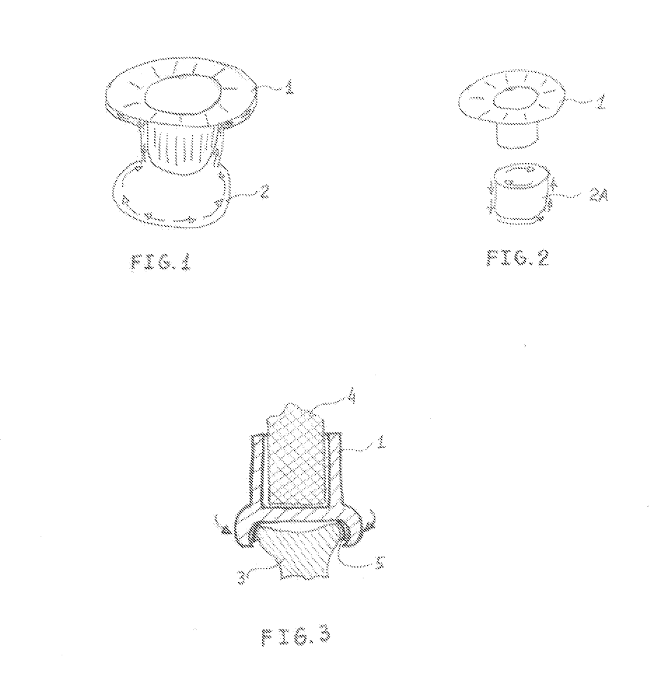

A first embodiment of the invention is illustrated on FIG. 1. A candleholder (1) substantially has a shape of a hollow cylinder capable to enclose a candle, which cylinder includes sidewalls and a round bottom closing the cylinder on the underside, and serving to hold the candle. The cylinder also includes a top opening with its edges coupled to a planar ring-like shelf. A double-stick adhesive attachment (2) is coupled with its first (inner) side to the outside surface of the bottom of candleholder 1, and to the outside surface of the sidewalls of candleholder 1. The second (outer) side of the adhesive attachment 2 is covered by a removable cover (not illustrated), which can be removed before usage to attach the candleholder 1 to the candelabra.

In the first embodiment, optionally the double-stick adhesive material can be substituted with one-side Velcro.™ strips or magnetic strips coupled to the sidewalls and bottom of candleholder 1, and, on the other hand, to the candelabra in the place of contact with the bottom of candleholder 1. The candleholder 1 will be thusly attachable to the candelabra, and removable therefrom.

A second embodiment of the invention is illustrated on FIG. 2, depicting a candleholder 1 similar to the one of the first embodiment. A double-stick adhesive attachment (2A) has a hollow cylindrical shape with the sidewalls, the top and bottom openings. The inner surface of the sidewalls of adhesive attachment 2A is coupled with the outside surface of the sidewalls of candleholder 1. The outer surface of the sidewalls of adhesive attachment 2A is covered by a removable cover (not illustrated), which can be removed before usage to attach the candleholder 1 to the candelabra.

Adhesive attachments 2 and 2A (FIGS. 1, 2) may comprise a number (one or more) double-stick adhesive elements, wherein each element may have its own removable cover, or a common removable cover may cover entirely or partially the candleholder. In order to provide attachment, the cover (or covers) should be removed, and the adhesive layer of each element is brought into contact with the candelabra.

In some embodiments the adhesive elements can be coupled to the candelabra (as opposed to the candleholder) and covered with a cover, which cover then may be removed for attachment of the candleholder.

Similarly, the second embodiment may optionally utilize the aforesaid Velcro.™ strips or magnetic strips situated in the places of contact between the candleholder 1 and attachment 2A.

A third embodiment of the invention is illustrated on FIG. 3, showing a sectional view of a candleholder 1, including a hollow cylinder with sidewalls and a preferably planar round bottom having a diameter greater than the cylinder's diameter. A candle (4) is exemplarily shown inserted into the candleholder 1. The edges of the round bottom of candleholder 1 can be bent downwardly.

The underside of the round bottom can be furnished with a number (one or more) double-stick adhesive predeterminedly shaped pieces or adhesive elements (5), or with one ring-shaped double-stick adhesive element.

The adhesive elements 5 each have a first side and a second side performed as adhesive layers. The first side of each element 5 is coupled to the underside of the round bottom of candleholder 1. The second side of each element 5 is preferably covered with a removable cover.

A candelabra (3) at least in the upper region is shaped as a cylinder-like body. The diameter of the round bottom is greater then of the cylinder-like body, as reflected on FIG. 3.

To secure the candleholder 1 to the candelabra 3, the edges of the round bottom are bent over the edges of candelabra 3 and the adhesive elements 5 with their second side are coupled to the candelabra edges. The round bottom may include radial triangular or other shaped cuts to facilitate the bending of its edges over the edges of candelabra 3. The third embodiment is preferable where a substantial shaking of the candleholder and candelabra may be expected.

Similarly to the first and second embodiments, the third embodiment can deploy Velcro.™ or magnetic elements in place of the adhesive elements 5. They can be arranged in pairs: one Velcro.™ element (or magnetic element) is coupled to the round bottom facing its counterpart Velcro.™ element (or magnetic element) coupled to the candelabra 3.

If necessary, the adhesive attachments or Velcro.™ attachments composed of non-smokeable materials, as well as magnetic attachments can also be used to secure a candle within the candleholder. In some embodiments a non-smokeable adhesive element can be placed inside the candleholder to secure a candle therein.

Heat resistant materials (that will not melt or burn) should be used for the attachments. The attachments and candleholders may be made disposal or non-disposal.

Applying the knowledge disclosed in the instant description and drawings, other embodiments may be designed having adhesive, Velcro.™, and/or magnetic (collectively—“attachment”) elements or any suitable combination thereof, positioned at any place of contact between the candleholder and the candelabra, which from the standpoint of prior art will constitute essential characteristics of the generic or specific aspects of this invention.

I claim:

1. A method of attachment of a candleholder, with a candle inserted therein, to a candelabra or a similar device comprising the steps of providing said candleholder;
providing said candelabra or similar device;
providing attachment means in places of contact of said candleholder and said candelabra or similar device;
coupling said attachment means to said candleholder; and
coupling said attachment means to said candelabra or similar device, thereby securing said candleholder to said candelabra or similar device.

2. The method according to claim 1, wherein
said attachment means comprising attachment elements chosen from the group consisting of:
double-stick adhesive elements, Velcro.™ elements, magnetic elements, and any combination thereof.

3. The method according to claim 1, wherein
said candleholder at least partially shaped as a hollow cylinder including sidewalls and a round bottom;
said attachment means comprising a number of predeterminedly double-stick adhesive elements, each having a first and a second side, and the second side of each element covered with a removable cover;
the step of coupling said attachment means to said candleholder including
coupling the first side of each of said number of adhesive elements to the candleholder;
the step of coupling said attachment means to said candelabra or similar device including the sub-steps of:
removing the removable cover from the second side of each of said number of adhesive elements; and
coupling the second side of each of said number of adhesive elements to said candelabra or similar device.

4. The method according to claim 1, wherein
said candleholder at least partially shaped as a hollow cylinder including sidewalls;
said candelabra or similar device at least partially shaped as a hollow cylinder including sidewalls;
said attachment means comprising a hollow cylinder including sidewalls, the inner and outer surfaces of the sidewalls of said attachment means furnished with an adhesive layer, said hollow cylinder of said attachment means so configured that its inner surface capable to be coupled with the outside surface of the hollow cylinder of said candleholder, and its outer surface capable to be coupled with the inside surface of the hollow cylinder of said candelabra.

5. The method according to claim 1, wherein
said candelabra or similar device at least in the upper region shaped as a cylinder-like body;
said candleholder including a round bottom having a diameter greater than the diameter of the of said cylinder-like body;
the round bottom made of bendable material;
said attachment means configured as a number of double-stick adhesive elements including a first side and a second side;
the step of coupling said attachment means to said candleholder including:
coupling the first side of said attachment elements to the edges of the underside of the round bottom;
the step of coupling said attachment means to said candelabra or similar device including the sub-steps of:
bending the edges of the round bottom over the edges of said cylinder-like body; and
coupling the second side of said elements to the edges of said cylinder-like body.

6. A method of attachment of a candleholder, with a candle inserted therein, to a candelabra or a similar device comprising the steps of
providing said candleholder;
providing said candelabra or similar device;
providing attachment means in places of contact of said candleholder and said candelabra or similar device;
coupling said attachment means to said candelabra or similar device; and
coupling said attachment means to said candleholder, thereby securing said candleholder to said candelabra or similar device.

7. The method according to claim 1, further comprising the steps of:
providing a non-smokeable adhesive element inside the candleholder; and
coupling a candle within the candleholder to said non-smokeable adhesive element.
